(19) United States
(12) Patent Application Publication
(10) Pub. No.: US 2024/0346819 A1
(43) Pub. Date: Oct. 17, 2024

(54) DISASTER INVESTIGATION ASSISTANCE DEVICE, DISASTER INVESTIGATION ASSISTANCE METHOD, AND RECORDING MEDIUM

(71) Applicant: NEC Corporation, Minato-ku, Tokyo (JP)

(72) Inventors: Nana JUMONJI, Tokyo (JP); Yosuke Kimura, Tokyo (JP); Chisato Sugawara, Tokyo (JP); Takakazu Ishil, Tokyo (JP); Hiromichi Hirata, Tokyo (JP); Daisuke Hashizume, Tokyo (JP); Shouhel Ohno, Tokyo (JP)

(73) Assignee: NEC Corporation, Minato-ku, Tokyo (JP)

(21) Appl. No.: 18/574,931

(22) PCT Filed: Jul. 5, 2021
(86) PCT No.: PCT/JP2021/025290

§ 371 Date: Dec. 28, 2023

(51) Int. Cl. G06V 20/10; G01C 13/00; G01S 13/86; G01S 13/90; G06T 7/521; G06V 10/40; G06V 10/776; G06V 20/50

(52) U.S. Cl. CPC G06V 20/176; G01C 13/008; G01S 13/867; G01S 13/90; G06T 7/521; G06V 10/40; G06V 10/776; G06V 20/50; G06T 2207/10028; G06T 2207/30184; G06T 2207/30252

(57) ABSTRACT

In order to improve accuracy of an investigation of the disaster situation, a disaster investigation assistance device of the present invention includes a range determination means configured to determine a disaster range using a change in a ground surface that is a result of an analysis using a measurement result by a ground surface measurement device; an investigation region extraction means configured to extract an investigation region based on the disaster range; an image acquisition means configured to acquire an image acquired by an image acquisition device in the investigation region; and a water level determination means configured to determine a first water level in the investigation region using the acquired image.

### TECHNICAL FIELD

The present invention relates to assistance in disaster investigation, and in particular, to assistance in disaster investigation involving flood damage and the like.

### BACKGROUND ART

Synthetic aperture radars are used to grasp a disaster situation (see, for example, PTL 1). The disaster countermeasure assistance method described in PTL 1 grasps a disaster situation using radar image data acquired from a synthetic aperture radar.

### CITATION LIST

### Patent Literature

PTL 1: WO 2008/016153 A1

### SUMMARY OF INVENTION

### Technical Problem

When a disaster occurs, the disaster situation is investigated. The scope of investigation of the disaster situation is generally quite wide. Therefore, there is a demand for a technique for assisting investigation of a disaster situation. The technique described in PTL 1 is a technique using a synthetic aperture radar. For example, when investigating the influence of water damage such as a flood, the accuracy of determination using a synthetic aperture radar is about several meters. However, the accuracy of the investigation of the water level of the flood may be desirably about several centimeters to several tens of centimeters may be desirable.

An object of the present invention is to provide a disaster investigation assistance device and the like that solve the above problems and improve the accuracy of investigation of the disaster situation.

### Solution to Problem

A disaster investigation assistance device according to an aspect of the present invention includes a range determination means configured to determine a disaster range using a change in a ground surface that is a result of an analysis using a measurement result by a ground surface measurement device, an investigation region extraction means configured to extract an investigation region based on the disaster range, an image acquisition means configured to acquire an image acquired by an image acquisition device in the investigation region, and a water level determination means configured to determine a first water level in the investigation region using the acquired image.

A disaster investigation assistance system according to an aspect of the present invention includes the disaster investigation assistance device described above, the ground surface measurement device that outputs the measurement result to the disaster investigation assistance device, the image acquisition device that outputs the image to the disaster investigation assistance device, and a display device that displays the first water level determined by the disaster investigation assistance device.

An information processing method according to an aspect of the present invention includes determining a disaster range using a change in a ground surface that is a result of an analysis using a measurement result by a ground surface measurement device, extracting an investigation region based on the disaster range, acquiring an image acquired by an image acquisition device in the investigation region, and determining a first water level in the investigation region using the acquired image.

Alternatively, an information processing method according to an aspect of the present invention includes a disaster investigation assistance device executing the disaster investigation assistance method, the ground surface measurement device outputting a measurement result to the disaster investigation assistance device, the image acquisition device outputting the image to the disaster investigation assistance device, and the display device displaying the first water level determined by the disaster investigation assistance device.

A recording medium according to an embodiment of the present invention records a program for causing a computer to execute determining a disaster range using a change in a ground surface that is a result of an analysis using a measurement result by a ground surface measurement device, extracting an investigation region based on the disaster range, acquiring an image acquired by an image acquisition device in the investigation region, and determining a first water level in the investigation region using the acquired image.

### Advantageous Effects of Invention

According to the present invention, it is possible to achieve an effect of improving the accuracy of investigation of the disaster situation.

### BRIEF DESCRIPTION OF DRAWINGS

FIG. 1 is a block diagram illustrating an example of a configuration of a disaster investigation assistance system according to a first example embodiment.

FIG. 2 is a conceptual diagram illustrating an example of a configuration of the disaster investigation assistance system according to the first example embodiment.

FIG. 3 is a diagram for describing an investigation region.

FIG. 4 is a diagram illustrating an example of a position where a dashcam has acquired an image.

FIG. 5 is a diagram illustrating an example of a position of an image acquired by an image acquisition unit.

FIG. 6 is a diagram for describing an example of water level determination using a trace.

FIG. 7 is a diagram illustrating an example of output of an image.

FIG. 8 is a flowchart illustrating an example of an operation of the disaster investigation assistance device according to the first example embodiment.

FIG. 9 is a block diagram illustrating an example of a hardware configuration of the disaster investigation assistance device.

FIG. 10 is a block diagram illustrating an example of a configuration of a disaster investigation assistance device according to a second example embodiment.

FIG. 11 is a block diagram illustrating an example of a configuration of a disaster investigation assistance system according to a third example embodiment.

### EXAMPLE EMBODIMENT

Next, an example embodiment of the present invention will be described with reference to the drawings. Each drawing is for describing an example embodiment of the present invention. However, the example embodiment of the present invention is not limited to the description of each drawing. Similar configurations in the respective drawings are denoted by the same reference numerals, and repeated description thereof may be omitted. In the drawings used in the following description, configurations of portions not related to the solution of the problem of the present invention may be omitted and not illustrated.

### Terms

The “image acquisition device” is a device that includes a predetermined imaging device and acquires an image related to a structure (for example, a road, a bridge, a slope frame, an embankment, a pier, a revetment, or a runway) and the surroundings thereof. The image acquisition device may be a device (for example, a dashboard camera(dashcam)) that is mounted on or towed by a mobile object (for example, a vehicle, an unmanned aerial vehicle (drone), or a person) and moves, or may be a fixed device (for example, a fixed camera). The fixed camera used as the image acquisition device is not limited to a camera having a fixed imaging direction, and may be a camera capable of changing the imaging direction within a certain range.

The “image” acquired by the image acquisition device is an image including a structure. The image may include the surroundings of the structure. For example, the image is an image including a road and surroundings of the road (for example, a sign, another vehicle, and a traffic light) imaged by a dashcam mounted on a vehicle (for example, a four-wheeled or two-wheeled motor vehicle) traveling on a structure such as a road and a bridge. The image may be a still image or an image including a plurality of still images such as a moving image. Alternatively, the image may be an image including images in a plurality of directions such as front, left and right sides, and rear. In a case where images in a plurality of directions are included, the image may be an image in which images in a plurality of directions in one image are combined, or may be a set of images including images in a plurality of directions.

Further, the image may include information related to the image in addition to the still image and the moving image. For example, the image may include information related to the image acquisition device (focal distance, number of pixels, and the like) and information related to the acquisition of the image (imaging time, imaging position, and the like) (hereinafter, these are collectively referred to as “image acquisition information”). Alternatively, the image may include information related to a mobile object (for example, a vehicle) on which the image acquisition device that acquired the image is mounted. For example, an image may include “operation information of mobile object (for example, operation information such as an accelerator pedal, a brake pedal, a shift lever, a steering wheel, a wiper, a blinker, and opening and closing of a door of a vehicle)”. Alternatively, the image may include “information added by an operator (for example, the operator's comments on the situation of the disaster and the traces of the disaster)” who has performed the task of acquiring the image. Alternatively, the image may include “surrounding information (for example, weather, temperature, humidity, intensity of illumination, or voice)” in the acquisition of the image.

As such, an image may include information associated with the image. Hereinafter, the information included in the image excluding the image (the still image and the moving image) is collectively referred to as “information related to an image” or “image related information”. However, the image related information may be treated as information different from the image. For example, the image and the image related information may be stored as image data and metadata in one image file. However, in the following description, an image will be described as including information related to the image (image related information). In the following description, a dashcam is used as an example of the image acquisition device. A vehicle is used as an example of the mobile object.

As described later, each example embodiment uses an image acquired in a predetermined region among images acquired by an image acquisition device. Therefore, any of the configurations selects an image of a predetermined region from the images acquired by the image acquisition device. However, in each example embodiment, the configuration for selecting an image is not limited. For example, the image acquisition device may acquire a region of the image to be output to output the image of the region. Alternatively, a predetermined system (for example, a cloud computing system) may select the image. For example, a storage device included in a predetermined cloud computing system acquires and stores an image from the image acquisition device. Then, an output device included in the system may select and output an image of a predetermined region. Alternatively, the disaster investigation assistance device of each example embodiment may select an image of a predetermined region from among the acquired images. In the following description, these cases will be collectively described as follows. In each example embodiment, the disaster investigation assistance device acquires an image acquired by the image acquisition device in a predetermined region.

Each example embodiment determines the water level related to the disaster using the image acquired from the image acquisition device. For example, each example embodiment determines the water level of a water related disaster (flood), such as a flood and storm surge. However, the water level to be determined is not limited to a water level such as a flood or a storm surge. For example, each example embodiment may determine the water level of water immersion and flooding occurring in a typhoon, a concentrated heavy rain, or the like. That is, the disaster includes a disaster accompanied by rainfall such as a typhoon and a concentrated heavy rain. Alternatively, the disaster may be a disaster including an object other than water, such as a debris flow. Alternatively, the disaster includes a disaster associated with destruction of a structure, such as breakage of a dam or an embankment. Alternatively, the disaster includes a human disaster such as improper opening of a water gate. In the following description, a flood is used as an example of a disaster. That is, in the following description, the image acquired by the image acquisition device is used for determining the water level of the flood. As such, at least some images include at least any one of a water surface of the flood and a trace of the flood. In the case of using an image including a trace, in each example embodiment, a predetermined trace determined by the user or the like may be used as the trace of the flood. For example, the trace of the flood is at least any one of mud, garbage, grass, and the like left on at least any one of a fence, a utility pole, a post, a wall of a building, and the like. Alternatively, the trace of the flood may be at least any one of driftwood left on a bank or the like, fallen grass, a trace of earth and sand that have flowed out, and the like. However, the disaster is not limit to the flood. For example, the flood range in the following description is an example of the disaster range.

The side face of the structure has at least one (hereinafter, referred to as a “vertical face”) of a flat face and a curved face constructed perpendicular to the horizontal face. The vertical face is not limited to a face that is vertical in a geometrically strict sense, but includes a face recognized as a face in a vertical direction as a structure, such as a wall of a general building. For example, the vertical face is a face of a column, a wall, or the like that falls within a tolerance range in a general building or the like. Alternatively, the vertical face includes a face that has a predetermined angle relative to the vertical line, such as a side of a tapered column, but is generally determined to be substantially vertical.

On the other hand, as in a slope for a wheelchair, a face of the structure includes at least any one of a flat face and a curved face (hereinafter, referred to as a “slope”) that is inclined at a certain angle with respect to a vertical face. The water level of the slope is more likely to change than the water level of the vertical face due to the influence of the relationship between the direction of the flow of the flood and the direction of the slope. For example, the water level when the flood is flowing along the slope is generally the water level of the flood. However, when the flood flows toward the slope, the flood reaches a place higher than the water level of the flood. Therefore, the water level when the flood flows toward the slope tends to be higher than the water level of the flood. The degree of increase is not constant and changes in accordance with the flow velocity of the flood. As described above, an error in the water level in the slope is likely to occur, compared with that in the vertical face.

Therefore, the trace used for determining the water level is preferably the trace remaining on the vertical face rather than the trace remaining on the slope. Therefore, the image used in each example embodiment is desirably an image including a vertical face or a structure (a concrete wall, a utility pole, a poster, a general building, etc.) having a vertical face. However, for example, a trace of a flood may remain in street trees or fences using trees. Therefore, each example embodiment may use not only an image of an artificial structure but also an image including a predetermined tree. However, in the following description, for convenience of description, the image is referred to as an image including a predetermined structure, including an image including a predetermined tree.

As in the case of selecting an image of a predetermined region, a configuration for selecting an image including a vertical face or a predetermined structure is not limited. For example, the image acquisition device may select and outputs an image including a vertical face or a predetermined structure from the acquired image. Alternatively, a predetermined cloud computing system may select the image. For example, a storage device included in a predetermined cloud computing system acquires and stores an image from the image acquisition device. Then, an output device included in the system may select and outputs an image including a vertical face or a predetermined structure. Alternatively, the disaster investigation assistance device of each example embodiment may select an image including a vertical face or a predetermined structure.

The “synthetic aperture radar (hereinafter referred to as an “SAR”)” is a radar in which while moving, a flying object transmits and receives a radio wave and obtains an image equivalent to an antenna having a large opening. The resolution in radar observation is improved as the antenna is increased. However, the size of an antenna that can be mounted on an artificial satellite or the like is limited. Therefore, the SAR transmits and receive radio waves using an antenna having a small actual aperture length while flying (that is, by artificially “synthesizing” the “aperture”), thereby improving resolution in the traveling direction (that is, a virtually large antenna is configured). The flying object may be any flying object as long as it is a flying object equipped with the SAR. For example, the flying object is an artificial satellite, an aircraft, or an unmanned aerial vehicle (drone).

The SAR outputs an image (hereinafter, referred to as an “SAR image”) as a measurement result. Each example embodiment can analyze a “change in the earth's surface (hereinafter, it may be simply referred to as a “change in a ground surface”)” using SAR images. For example, each example embodiment can analyze a change in height of the ground surface between two times as a change in the ground surface using two SAR images at different times at the same location. Alternatively, the SAR can analyze a change in intensity of the ground surface as a change in the ground surface. The SAR may use any method as a method for analyzing a change in height and a change in intensity. For example, the SAR may use techniques such as change extraction, time series interference analysis, and coherent change extraction. Alternatively, the SAR may apply the SAR image to an analysis model on which machine learning in which past SAR images or the like are applied to a predetermined model is executed and is generated as a result of execution of the machine learning and analyze a change in the ground surface. The analysis of a change in the ground surface is not limited to the analysis of a change in height of the ground surface and a change in intensity of the ground surface, and may also include other analyses (for example, an analysis of a factor of a change in the ground surface or an analysis of a magnitude of a risk based on a change in the ground surface, or the like). As described above, the SAR is a device that measures the ground surface in order to acquire the measurement result (for example, an SAR image) for analyzing a change in the ground surface.

However, in each example embodiment, a device that acquires a measurement result for analyzing a change in the ground surface, that is, a device that measures the ground surface, is not limited to the SAR. Examples of the device that measures the ground surface include an optical sensor or a laser measuring device mounted on any of an artificial satellite, an aircraft, and an unmanned aerial vehicle (drone). Each example embodiment may analyze a change in the ground surface using measurement results by a device or a system that measures the ground surface as described above. In the following description, these devices or a systems that measure the ground surface are collectively referred to as a “ground surface measurement device”.

The ground surface measurement device includes a device that analyzes a “change in a ground surface” using a measurement result to output the “change in the ground surface” that is a result of the analysis. That is, the ground surface measurement device may output a measurement result or may output a change in the ground surface as an analysis result. Therefore, in the following description, in order to avoid complication of the description, the above cases will be summarized unless otherwise distinguished, and the disaster investigation assistance device will be described as acquiring a change in the ground surface that is a result of an analysis using the measurement result by the ground surface measurement device. In the following description, the SAR and the SAR image are used as examples of the ground surface measurement device and the measurement result.

The SAR includes a device capable of acquiring a measurement result using a plurality of frequencies (multispectra). When the measurement result using the multispectra is used, not only the change in the ground surface but also the type of the ground surface can be analyzed. Therefore, each example embodiment may analyze the type of the ground surface using the measurement result of SAR using multispectra, and use the analyzed type of the ground surface. The type of the ground surface is determined in accordance with the frequency to be used. For example, the type of the ground surface includes at least any one of a water surface, mud, garbage, dry soil, a grassland, a forest, and snow cover.

In a case where an image acquired by the image acquisition device and an image acquired by the ground surface measurement device are distinguished from each other, the image acquired by the image acquisition device is referred to as a “first image”, and the image acquired by the ground surface measurement device is referred to as a “second image”. For example, the first image is an image including a structure (a concrete fence, a utility pole, a poster, a general building wall, and the like) including a vertical face. In other words, the first image is, for example, an image acquired by a device facing the horizontal direction or an angle close to the horizontal direction, such as an image captured by a dashcam mounted on a vehicle traveling on a road. That is, the first image is an image acquired by the device substantially facing the vertical face.

On the other hand, the second image is an image obtained by imaging or measuring the ground surface from a certain altitude. Therefore, the second image is, for example, an image acquired or measured by a device facing the vertical direction or an angle close to the vertical direction with respect to the ground surface, such as the SAR image acquired by the SAR mounted on the artificial satellite. That is, the second image is an image acquired or measured by a device substantially facing a horizontal face.

In other words, the first image is an image that includes at least a face (vertical face) perpendicular to the ground surface in a determinable manner. On the other hand, the second image is an image mainly including the ground surface. The second image may include, as the ground surface, not only a ground surface such as a road, a farmland, and a river, but also an upper portion of a building such as a rooftop or a roof. As described above, the first image is an image having an imaging direction different from that of the second image. For example, the first image acquired by the image acquisition device mounted on the drone is different in the acquisition direction of the image from the second image acquired by the ground surface measurement device mounted on the drone. Specifically, for example, the image acquisition device is mounted on the drone in such a way as to capture an image in the horizontal direction. On the other hand, the ground surface measurement device is mounted on a drone in such a way as to measure or capture an image in the vertical direction (a direction toward the ground surface).

The measurement result (second image) by the ground surface measurement device such as the SAR includes a wide range to some extent. Therefore, the analysis using the measurement result (second image) by the ground surface measurement device such as the SAR can acquire a certain wide range of a change in the ground surface. However, the accuracy of the analysis result (change in the ground surface) using the measurement result acquired by the SAR is about several meters. The accuracy of the water level of a disaster such as a flood is desirably about several centimeters to a dozen centimeters.

For example, in the case of a flood, an investigation of the water level of the flood is carried out. The accuracy of the investigation of the water level of the flood is desirably about several centimeters to several tens of centimeters. However, when the water level is determined using the synthetic aperture radar, the accuracy of the water level is about several meters. As described above, the measurement of the synthetic aperture radar may not necessarily achieve the required accuracy to determine the water level of the flood. Therefore, under the present circumstances, local government staff members and the like visit a disaster-stricken region of the flood and investigate the water level of the flood. For example, after the flood has subsided, local government staff members and the like have invested a trace of the flood (for example, traces of mud remaining on the utility pole and the wall, or attached grass) and determined the water level of the flood from the position of the trace. Therefore, manual investigation by local government staff members and the like is a considerable burden on the staff members and the like. Wind and rain, wind and waves, and the like make a trace of a flood unclear. Therefore, trace investigation is required to be performed promptly after the flood. There is a plurality of types of traces used for determining the water level at the time of the flood, and the remaining position is also different for each flood. Therefore, a person in charge of flood investigation needs a certain degree of investigation experience. Human determination is likely to have variations in accuracy. Therefore, a technique for assisting in determination of a water level of a disaster such as a flood is desired.

On the other hand, the accuracy of determination using the image (first image) acquired from the dashcam is about several centimeters to several tens of centimeters. However, the image (first image) acquired by the dashcam is an image with a considerably narrow range relative to the measurement result by the SAR (second image). Therefore, in a case where images are acquired at all positions in a region to be managed by a local government using a dashcam, a lot of time and man-hours are required to acquire the images.

For example, in a case where a disaster range in a predetermined region is identified using images acquired by a dashcam, it is necessary to acquire images in the entire region using the dashcam. Such work requires considerably a lot of time and man-hours. It is desirable to promptly execute the trace investigation of the flood. Therefore, in a case where the image acquired by the dashcam is used for investigating the water level of the flood, it is desired to narrow down the region where the image is acquired, in other words, to provide an effective region (hereinafter, referred to as an “investigation region”) for investigating the water level. A plurality of water levels is assumed as the water levels of the flood to be determined. For example, the water levels of the flood to be determined include the water level at the time of investigation (for example, the water level investigated during the flood) and the highest water level until the time of investigation (for example, a water level to be determined using a trace or the like after a flood has subsided).

Therefore, as described below, each example embodiment of the present invention determines a water level of a disaster (for example, a flood) using a change in the ground surface that is a result of an analysis using a measurement result by the ground surface measurement device and an image acquired by the image acquisition device. That is, each example embodiment of the present invention improves the accuracy of investigation of the disaster situation. Alternatively, each example embodiment of the present invention can reduce at least any one of man-hours and time in investigation of the disaster situation.

### First Example Embodiment

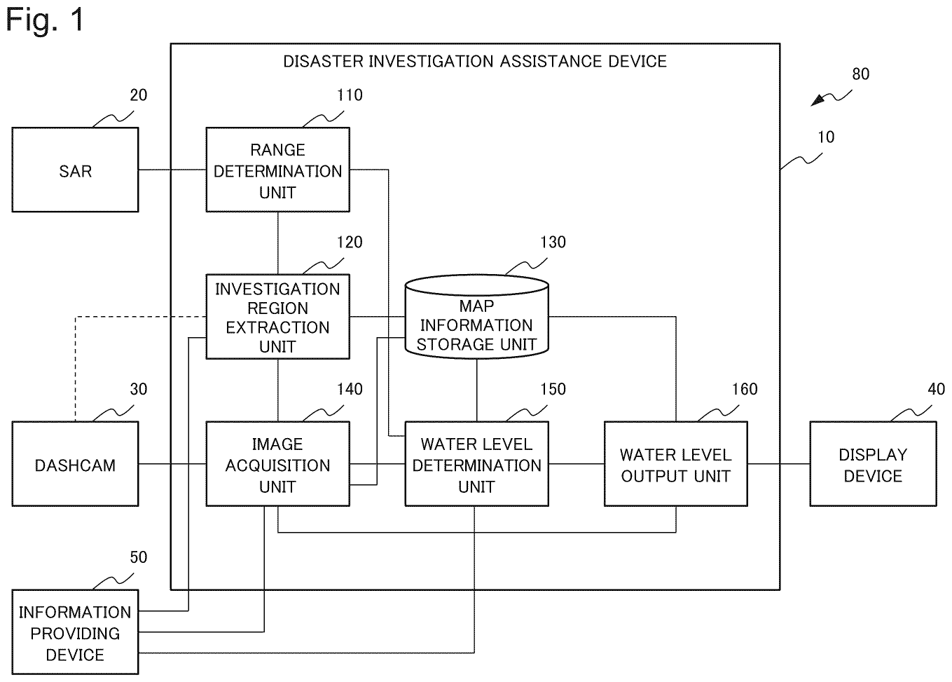

A first example embodiment of the present invention will be described with reference to the drawings. FIG. 1 is a block diagram illustrating an example of a configuration of a disaster investigation assistance system 80 according to the first example embodiment. The disaster investigation assistance system 80 includes a disaster investigation assistance device 10, an SAR 20, a dashcam 30, a display device 40, and an information providing device 50. The number of components in FIG. 1 is an example, and is not limited to the number illustrated in FIG. 1. For example, the disaster investigation assistance system 80 may include a plurality of dashcams 30.

The SAR 20 outputs a measurement result (second image) or a change in the ground surface to the disaster investigation assistance device 10. For example, the SAR 20 outputs an SAR image as a measurement result to the disaster investigation assistance device 10. In this case, the disaster investigation assistance device 10 may analyze the “change in the ground surface” using the SAR image acquired from the SAR 20. When the disaster investigation assistance device 10 acquires the SAR image, the disaster investigation assistance device 10 may output a range (for example, an imaging range or a measurement range) of the SAR image to the SAR 20. In this case, the SAR 20 may output the SAR image of the acquired range to the disaster investigation assistance device 10.

Alternatively, the SAR 20 may output, to the disaster investigation assistance device 10, a “change in the ground surface” that is a result of analyzing the SAR image. When the disaster investigation assistance device 10 acquires a change in the ground surface, the disaster investigation assistance device 10 may output a range of a change in the ground surface (for example, the analysis range) to the SAR 20. In this case, the SAR 20 may output a change in the ground surface in the acquired range. The SAR 20 may measure the ground surface using multispectra. In this case, the SAR 20 may output a multispectral measurement result or may output a type of ground surface analyzed using the multispectral measurement result.

The dashcam 30 outputs an image (first image) to the disaster investigation assistance device 10. The dashcam 30 is mounted on a vehicle, for example, acquires an image of a road or the like on which the vehicle travels, and outputs the acquired image. However, the mobile means of the dashcam 30 is not limited to the vehicle. For example, the dashcam 30 may be mounted on a mobile object (for example, a drone) other than the vehicle. Alternatively, a person or the like may carry the dashcam 30. Alternatively, the dashcam 30 may be a non-moving device such as a fixed camera.

The disaster investigation assistance systems 80 may include a plurality of dashcams 30 instead of one dashcam 30. In this case, at least part of the mobile means of each dashcam 30 may be different. For example, the disaster investigation assistance system 80 may include a dashcam 30 mounted on the vehicle and a dashcam 30 fixed at a predetermined position.

As described later, the disaster investigation assistance device 10 uses the image of the investigation region in the image acquired by the dashcam 30. However, as described above, the configuration for selecting the image of the investigation region is not limited. For example, the dashcam 30 may acquire the investigation region from the disaster investigation assistance device 10 to output an image of the acquired investigation region. Alternatively, a device or a system (not illustrated) may store the images acquired by the dashcam 30, select an image of the investigation region from the stored images, and output the selected image to the disaster investigation assistance device 10. Alternatively, the disaster investigation assistance device 10 may select an image of the investigation region from the acquired images. In the following description, it is assumed that the disaster investigation assistance device 10 acquires an image acquired in the investigation region by the dashcam 30.

The display device 40 displays the water level output by the disaster investigation assistance device 10. The display device 40 may be any device as long as the device displays the water level. For example, the display device 40 may be a display included in a disaster assistance system of a local government. The installation position of the display device 40 may be any place where it can be installed. Furthermore, the display device 40 may be a device included in any device or a device including another device. For example, the display device 40 may be included in the disaster investigation assistance device 10. Alternatively, the display device 40 may be a device including the disaster investigation assistance device 10.

The information providing device 50 provides information requested from the disaster investigation assistance device 10. The information providing device 50 may be any device as long as it provides information requested from the disaster investigation assistance device 10. The user or the like of the disaster investigation assistance device 10 may determine the information to be acquired from the information providing device 50 and the information providing device 50 in consideration of the information necessary for determining the water level in the disaster investigation assistance device 10. For example, the information providing device 50 may provide map information such as roads to the disaster investigation assistance device 10. Alternatively, the information providing device 50 may provide weather information to the disaster investigation assistance device 10. Alternatively, the information providing device 50 may provide the disaster investigation assistance device 10 with the position of a predetermined structure (for example, a water level observation station).

The disaster investigation assistance device 10 acquires an SAR image from the SAR 20, and analyzes a change in the ground surface using the acquired SAR image. Alternatively, the disaster investigation assistance device 10 acquires, from the SAR 20, a change in the ground surface that is a result of analyzing the SAR image acquired by the SAR 20. That is, although the subject of the analysis is different, the disaster investigation assistance device 10 acquires a change in the ground surface that is a result of an analysis using the measurement result (SAR image) by the SAR 20. Then, the disaster investigation assistance device 10 determines a disaster range (for example, the range of the flood) using the acquired change in the ground surface. Then, the disaster investigation assistance device 10 extracts the investigation region based on the disaster range. Then, the disaster investigation assistance device 10 acquires an image acquired by the dashcam 30 in the investigation region. Then, the disaster investigation assistance device 10 determines the water level in the investigation region using the acquired image. Then, the disaster investigation assistance device 10 outputs the determined water level.

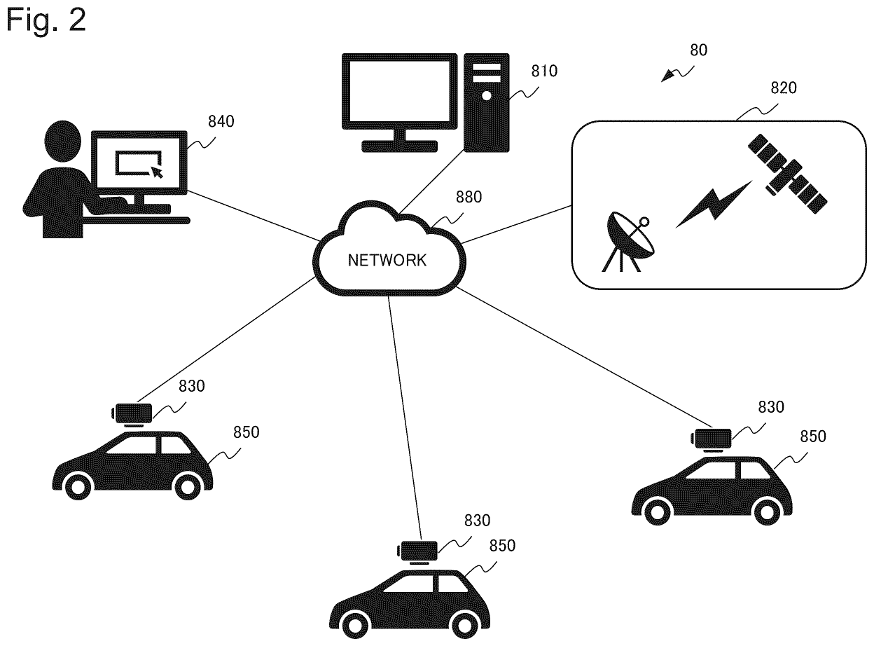

FIG. 2 is a conceptual diagram illustrating an example of a configuration of the disaster investigation assistance system 80 according to the first example embodiment. The disaster investigation assistance system 80 of FIG. 2 includes a computer 810 as an example of the disaster investigation assistance device 10, an SAR system 820 including an artificial satellite and a ground station as an example of the SAR 20, and a dashcam 830 as an example of the dashcam 30. Further, the disaster investigation assistance system 80 of FIG. 2 includes a terminal device 840 as an example of the display device 40. Further, the disaster investigation assistance system 80 of FIG. 2 includes a vehicle 850 as an example of a mobile object that moves with the dashcam 830 mounted thereon. Further, the disaster investigation assistance system 80 of FIG. 2 includes a network 880 as a communication path for connecting respective devices and systems. The network 880 is a communication path that connects each device and the system to each other. The network 880 is not particularly limited as long as each device and the system can be connected. For example, the network 880 may be the Internet, a public telephone line, or a combination thereof.

The number of configurations included in FIG. 2 is an example, and is not limited to the number illustrated in FIG. 2. For example, the disaster investigation assistance system 80 may include one, two, or four or more dashcams 830. Alternatively, at least some of the dashcams 830 may not be mounted on the vehicle 850. For example, the disaster investigation assistance system 80 may include a fixed camera as the dashcam 830. In FIG. 2, the dashcam 830 is displayed outside the vehicle 850 for easy understanding. However, the dashcam 830 may be mounted inside the vehicle 850.

The SAR system 820 outputs an SAR image acquired using an artificial satellite to the computer 810. The computer 810 acquires the SAR image from the SAR system 820 and analyzes a change in the ground surface using the acquired SAR image. However, the computer 810 may obtain a change in the ground surface from the SAR system 820. That is, the computer 810 acquires a change in the ground surface that is a result of an analysis using the SAR image acquired by the SAR system 820. Then, the computer 810 determines the investigation region using a change in the ground surface.

The vehicle 850 on which the dashcam 830 is mounted travels on a structure such as a road or a bridge. The dashcam 830 is mounted on the vehicle 850 and acquires the image of a road, a bridge, and the like on which the vehicle 850 travels. Then, the computer 810 acquires the image of the investigation region from the dashcam 830. As described above, the configuration for selecting the image of the investigation region from among the images acquired by the dashcam 830 is not limited. For example, the dashcam 830 may acquire the investigation region from the computer 810, select an image of the acquired investigation region, and output the image to the computer 810. Alternatively, a device (not illustrated) may select an image of the investigation region. Alternatively, the computer 810 may select an image of the investigation region from among the acquired images. Then, the computer 810 determines the water level using the image of the investigation region. Then, the computer 810 outputs the determined water level to the terminal device 840. The terminal device 840 displays the water level acquired from the computer 810.

The computer 810, the SAR system 820, the dashcam 830, the terminal device 840, and the vehicle 850 included in the disaster investigation assistance system 80 are not particularly limited. As the computer 810, the SAR system 820, the dashcam 830, the terminal device 840, and the vehicle 850, generally available products and systems may be used. Therefore, a detailed description thereof will be omitted.

Next, a configuration of the disaster investigation assistance device 10 will be described with reference to FIG. 1. The disaster investigation assistance device 10 includes a range determination unit 110, an investigation region extraction unit 120, a map information storage unit 130, an image acquisition unit 140, a water level determination unit 150, and a water level output unit 160. Each configuration may store at least part of the information determined by each configuration, the extracted information, and the acquired information in a storage unit (not illustrated). In this case, each configuration may acquire necessary information from the storage unit.

The range determination unit 110 acquires a change in the ground surface that is a result of an analysis using the SAR image acquired by the SAR 20. For example, the range determination unit 110 acquires an SAR image from the SAR 20, and analyzes a change in the ground surface in the acquired SAR image. Alternatively, the range determination unit 110 may acquire, from the SAR 20, a change in the ground surface that is a result of an analysis of the SAR image. In this case, the range determination unit 110 may omit the operation of analyzing the change in the ground surface.

As described above, the range determination unit 110 may acquire the SAR image from the SAR 20 to analyze the change in the ground surface, or may acquire the change in the ground surface from the SAR 20. Therefore, as already described, in the description of the present example embodiment, for convenience of description, it is assumed that the range determination unit 110 acquires a change in the ground surface that is a result of an analysis using the SAR image acquired by the SAR 20. That is, the acquisition of the change in the ground surface in the range determination unit 110 includes the case of acquiring the SAR image to analyze the change in the ground surface using the acquired SAR image and the case of acquiring the change in the ground surface.

The range determination unit 110 may acquire the observation result using multispectra from the SAR 20. In this case, the range determination unit 110 may analyze the type of the ground surface in addition to the change in the ground surface using the acquired observation result. Alternatively, the range determination unit 110 may acquire, from the SAR 20, a type of the ground surface that is an analysis result of the observation result using multispectra. As described above, the type of the ground surface is one of the analysis results of the observation result. Therefore, in the following description, the change is referred to as a change of the ground surface including the type of the ground surface unless distinction is particularly necessary. That is, in the following description, the change in the ground surface may include the type of ground surface.

Then, the range determination unit 110 determines the range of the flood using the change in the ground surface that is a result of an analysis using the measurement result by the SAR 20. The water surface in the range of the flood is higher than normal ground surface due to flooding. Therefore, for example, the range determination unit 110 determines a range in which the change in the ground surface is higher than a predetermined threshold value as the range of the flood. Alternatively, in consideration of the error, the range determination unit 110 may determine a range in which the change in the ground surface is higher than the threshold value and a predetermined range (for example, a range of several tens of meters around the range) around the range as the range of the flood. In a case where the range determination unit 110 determines the type of the ground surface, the range determination unit 110 may determine the range of the flood using the type of the ground surface in addition to the change in the ground surface. For example, the range determination unit 110 may determine, as the range of the flood, a range in which the type of the ground surface is the water surface within a range in which the change in the ground surface is higher than the threshold value. Then, the range determination unit 110 outputs the determined flood range to the investigation region extraction unit 120.

The map information storage unit 130 stores map information. The information included in the map information is determined in accordance with the configuration and the operation using the map information. For example, the map information is information related to a road (a position, a length, a width, the number of lanes, a type of road surface, and the like of the road). Alternatively, the map information may be information (for example, the type and the location of the facility) related to a predetermined facility (for example, disaster related facility (for example, an evacuation station or a water level observation station)). Alternatively, the map information may include at least any one of an elevation, a terrain, and a type of the ground surface (for example, farmland, a grassland, or moorland). Then, the map information storage unit 130 outputs map information based on a request from any of the configurations. The disaster investigation assistance device 10 may acquire the map information from the information providing device 50 or a device (not illustrated) (server of map information provider). In this case, the disaster investigation assistance device 10 may not include the map information storage unit 130.

The investigation region extraction unit 120 extracts a region (investigation region) in which the water level is invested based on the range of the flood. The investigation region extraction unit 120 may extract the investigation region using the map information in addition to the range of the flood. For example, in a case where at least any one of a lake, a swamp, a pond, a river, and a water passage is included in the range of the flood, the investigation region extraction unit 120 may extract a region excluding these regions as the investigation region. Alternatively, in a case where the dashcam 30 is mounted on the vehicle, the investigation region extraction unit 120 may extract a region including a road through which the vehicle is configured to pass in the range of the flood with reference to the map information.

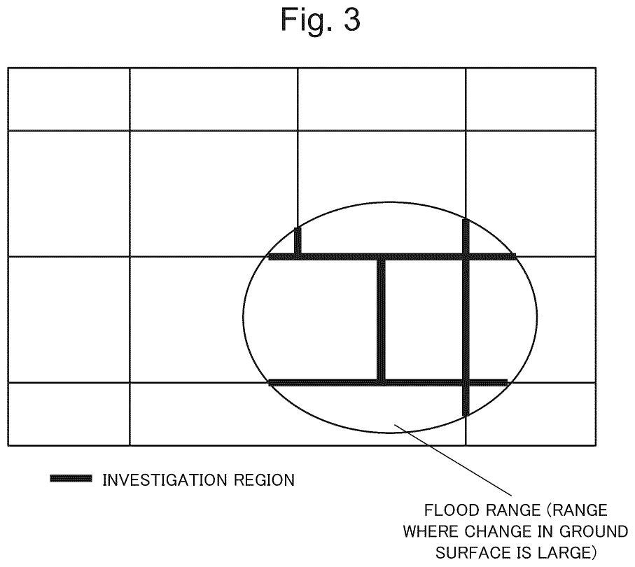

An example of this case will be described with reference to the drawings. FIG. 3 is a diagram illustrating an example of an investigation region. In FIG. 3, a straight line is a road. The ellipse is a range in which the change in the ground surface is determined by the range determination unit 110 to be large, that is, a range of a flood. The investigation region extraction unit 120 extracts a road (a thick line in FIG. 3) included the range of the flood determined by the range determination unit 110 to be the investigation region. The investigation region extraction unit 120 may extract a region around the road.

The investigation region is not necessarily a road. For example, in a case where the dashcam 30 is a fixed camera installed on a structure such as a steel tower or a building, the investigation region may include a position of the structure where the dashcam 30 capable of imaging the range of the flood is installed. Alternatively, in a case where a person carries the dashcam 30, the investigation region may be a region where a vehicle cannot pass but a person can pass (for example, an upper portion of each of a pier, a bank, and a revetment, or a passage for maintenance of a predetermined facility (for example, the water gate)). The investigation region may not be a linear region as in FIG. 3, but may be a region with a width. The description returns to the description with reference to FIG. 1.

The investigation region is a region where the water level determination unit 150 described later acquires an image used determining the water level. Among the facilities managed by local governments and the like, there is a facility important for countermeasures against flooding, such as water gates. There is a facility that measures the water level, such as a water level observation station of a river. It is preferable that the water level around such a facility is an object to be investigated. Therefore, the investigation region extraction unit 120 may extract the investigation region related to a predetermined facility. In this case, the investigation region extraction unit 120 may acquire the position information of the facility from the map information storage unit 130 or an external device (for example, the information providing device 50).

Alternatively, the investigation region extraction unit 120 may exclude a region having a change in predetermined the ground surface from the investigation region in the range of the flood. For example, in a range of a flood, a region where the change in the ground surface is higher than that of a house, a utility pole, or the like is a region where the flood reaches a position higher than the house or the like. Traces left in such regions are inadequate for determination of the water level because they are below the water level in the event of a flood. Therefore, the investigation region extraction unit 120 may exclude such a region (for example, a region where a change in the ground surface is larger than a height of a building.) from the investigation region.

In a case where the range determination unit 110 determines the type of the ground surface, the investigation region extraction unit 120 may extract the investigation region using the type of the ground surface. For example, the investigation region extraction unit 120 may extract the investigation region based on a range of a predetermined type (for example, mud or dry soil) of the ground surface. For example, the investigation region extraction unit 120 may extract the investigation region from the region of mud. In a case where the range of the flood does not include a region where the dashcam 30 cannot acquire the image, the investigation region extraction unit 120 may extract the range of the flood as the investigation region. Then, the investigation region extraction unit 120 outputs the extracted investigation region to the image acquisition unit 140.

The image acquisition unit 140 acquires the image of the investigation region from the dashcam 30. For example, the image acquisition unit 140 outputs the investigation region to the dashcam 30, and acquires an image captured in the investigation region from the dashcam 30. Alternatively, the image acquisition unit 140 may select the image of the investigation region from among the images acquired from the dashcam 30. Instead of the image acquisition unit 140, the investigation region extraction unit 120 may output the investigation region to the dashcam 30.

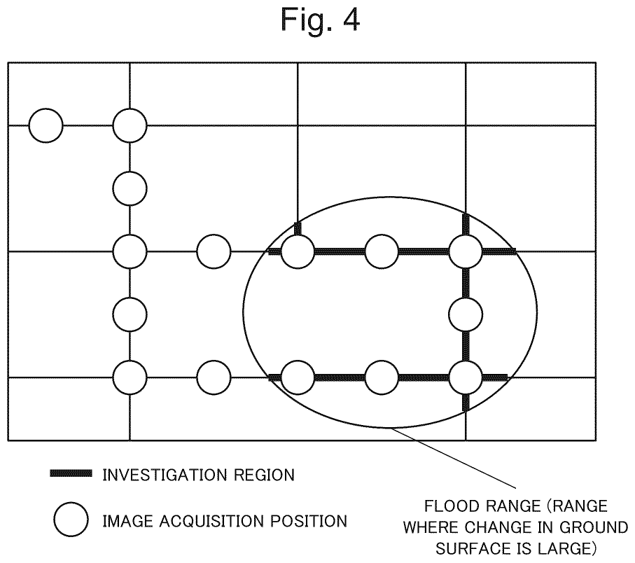

An example of an operation of image acquisition by the image acquisition unit 140 will be described with reference to the drawings. FIG. 4 is a diagram illustrating an example of a position where the dashcam 30 has acquired an image. The dashcam 30 acquires an image at a position indicated by a circle in FIG. 4. The dashcam 30 may acquire the image of the investigation region. For example, the dashcam 30 may acquire an image of the investigation region in FIG. 3. However, in general, the dashcam 30 is mounted on a vehicle or the like to continuously acquire images. Therefore, the dashcam 30 acquires images until arriving at the investigation region and also images when returning from the investigation region in addition to the investigation region. Therefore, in FIG. 4, the dashcam 30 acquires images of a region other than the investigation region.

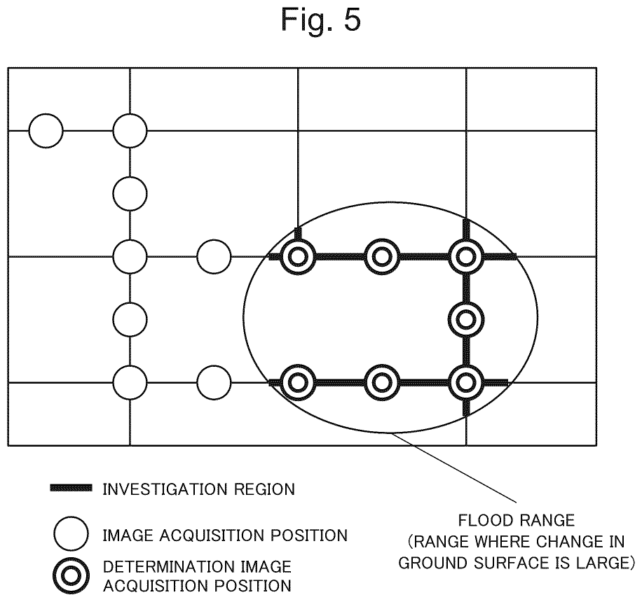

FIG. 5 is a diagram illustrating an example of positions of images acquired by the image acquisition unit 140. The image acquisition unit 140 acquires images acquired at positions included in the investigation region among the images acquired at respective positions illustrated in FIG. 4. In FIG. 5, the positions of the double circles are positions of the images acquired by the image acquisition unit 140. That is, in FIG. 5, the positions of the double circles are positions where the images used by the water level determination unit 150 described below to determine the water level are acquired. The description returns to the description with reference to FIG. 1.

In a case where the dashcam 30 has not acquired at least some of the images of the investigation region, the image acquisition unit 140 may request the dashcam 30 to acquire the images of the investigation region. In this case, for example, the driver of the vehicle on which the dashcam 30 is mounted may operate the vehicle to travel the investigation region in such a way that the dashcam 30 can acquire images. Alternatively, the image acquisition unit 140 may request the dashcam 30 (for example, a fixed camera) installed at a position where images can be acquired to acquire the images.

In a case where there is a plurality of dashcams 30, the image acquisition unit 140 may acquire images captured in the investigation region from all or some of the plurality of dashcams 30. In this case, at least some of the plurality of images may be images including the same point. Alternatively, a vehicle on which the dashcam 30 is mounted may pass through the same road a plurality of times. Also in this case, a plurality of images is images including the same point. As described above, in a case where at least some of the plurality of images are images including the same point, the image acquisition unit 140 may acquire all of the plurality of images including the same point, or may acquire one or some of the images. The image acquisition unit 140 outputs the acquired image to the water level determination unit 150.

The water level determination unit 150 determines the water level using the image of the investigation region. The water level determination unit 150 can use an any method as a method of determining the water level. For example, the water level determination unit 150 may determine the water level using predetermined image recognition. In the present example embodiment, the image recognition is not limited. For example, the image recognition includes recognition using a determination model, recognition using another method, and recognition using a combination of them.

For example, there is a water gauge as a device that determines a water level. Therefore, when determining the water level using the image including the water gauge, the user collects the images including the water gauge and the water surface in advance, executes machine learning in which the collected images are applied to a predetermined model, and generates a determination model as a result by the machine learning. Then, the user stores the generated determination model in the disaster investigation assistance device 10. Then, the water level determination unit 150 determines the water level of the water surface included in the image including the water gauge using the stored determination model. However, the image used for determining the water level by the water level determination unit 150 is not limited to the image including the water gauge. For example, the water level determination unit 150 may determine the water level using a predetermined structure (such as a utility pole) included in the image and the water surface.

The water level determination unit 150 may change the method of determining the water level using the information related to the image (image related information). For example, the water level determination unit 150 may store a plurality of determination models related to weather (for example, fine, cloudy, rainy, and snowy), and switch the determination models using the weather information included in the image related information. Alternatively, the water level determination unit 150 may combine the determination results of the plurality of determination models by changing the weights of the determination results of the plurality of determination models using the weather information included in the image related information.

Alternatively, the water level determination unit 150 may select an image to be used for determination using information related to the image. For example, when it is raining, the water level of the flood may not have reached the maximum water level. Therefore, the water level determination unit 150 may determine the water level using an image of predetermined weather (for example, cloudy after the end of rainfall) using weather information included in the image related information. In this manner, the water level determination unit 150 may determine the water level using the information related to the image.

Alternatively, imaging conditions such as the imaging direction of the dashcam 30 affect the determination of the water level. Therefore, the water level determination unit 150 may determine the water level using information related to acquisition of the image included in the information related to the image. For example, the information used for determining the water level is an imaging position, an installation height of the dashcam 30 in the mobile object, an installation angle of the dashcam 30, a distance from the dashcam 30 to the structure, an angle of view, and the like.

In determining the water level, the water level determination unit 150 may use information (for example, the elevation of the ground surface) included in map information related to the position of the image. For example, the water level is the height from the ground surface to the water surface during a flood. The value obtained by adding the water level to the elevation of the ground surface at each point is the elevation of the water surface at the time of the flood at each point. For example, in a case where the range of the flood is considerably wide, the flow of the flood occurs related to the difference in height (that is, the difference in elevation of the water surface) of the water surface in the flood of the range. The flow of the flood affects the scope of the damage and a change in the situation.

Therefore, the water level determination unit 150 may determine the elevation of the water surface at the time of the flood at each point using the elevation of each point acquired using the map information and the determined water level as the water level. In this manner, the water level determination unit 150 may determine the elevation of the water surface as the water level to be determined. The map information used by the water level determination unit 150 may be the same as the map information used by at least any one of the investigation region extraction unit 120 and the image acquisition unit 140 or different from neither map information. Further, as map information used for determination, the water level determination unit 150 may use map information stored in the map information storage unit 130, may use map information acquired from the information providing device 50, or may use map information acquired from a device (not illustrated).

Further, the water level determination unit 150 may determine a trace of the water surface included in the image using a predetermined method (for example, image recognition), and determine the water level at the time of the flood using the determined trace. For example, the user may collect images including a flood trace, generate a determination model for the trace as a result by machine learning using the collected images, and store the generated determination model for the trace in the disaster investigation assistance device 10. The trace used for the determination is a trace determined by the user or the like related to the structure to be invested. For example, the trace may be mud, garbage, grass, or the like left on a structure (a building, a fence, a utility pole, and the like) having a vertical face. Alternatively, the trace may be mud, garbage, or grass left on a fence or the like. Alternatively, the trace may be driftwood in a bank or the like, fallen grass, a rock that has flowed, or a trace of earth and sand that has flowed out (for example, a depression of a bank where earth and sand have flowed out).

When the image includes a plurality of types of structures, the water level determination unit 150 may determine the water level using a method (for example, image recognition) related to each of the types of structures. In a case where the image includes a plurality of types of traces, the water level determination unit 150 may determine the trace using a method (for example, image recognition) related to each of the types of traces.

Furthermore, in a case where the image includes a plurality of structures and a plurality of traces, the water level determination unit 150 may use a method (for example, image recognition) related to each of the combinations of the structures and the traces. The water level determination unit 150 may use a method other than image recognition as a method used for determining the water level and the trace. The user or the like may select an appropriate method for determining the water level and the trace based on the state of the flood, the acquired image, and the like.

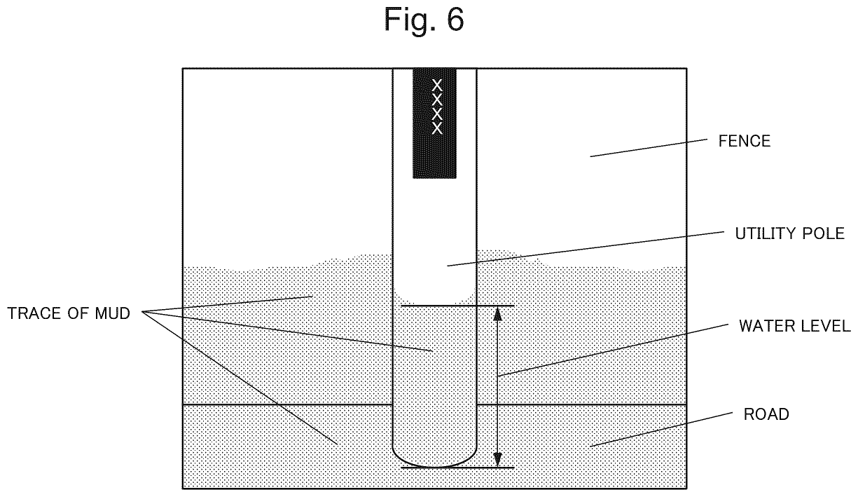

FIG. 6 is a diagram for describing an example of determination of a water level using a trace. FIG. 6 is an image including a utility pole, a fence, and a road after a flood. Traces of mud remain on the utility pole, the fence, and the road as traces of the flood. Therefore, for example, the water level determination unit 150 determines the height from the road (that is, the ground surface) to the upper part of the trace of mud of the utility pole as the water level. As described above, the side face of the utility pole is an example of a vertical face. However, the vertical face is not limited to the side face of the utility pole. For example, in FIG. 6, the fence is another example of a vertical face.

However, in FIG. 6, a narrow water passage is formed between the utility pole and the fence during the flood. A narrow water path typically has a higher water level than other portions. Therefore, in FIG. 6, the trace of mud of the fence in a range close to the utility pole is higher than other portions. As described above, it is better not to use a trace of a portion having a narrow water passage for determining the water level in the event of a flood. Therefore, the water level determination unit 150 may exclude a trace that is not appropriate for determining the water level, such as a fence near the utility pole in FIG. 6. Alternatively, the water level determination unit 150 may determine the water level by selecting a trace appropriate for determining the water level, such as the road side of the utility pole in FIG. 6. The description returns to the description with reference to FIG. 1.

A trace is more likely to remain properly in the vertical face than in the slope. Therefore, the water level determination unit 150 may select and use an image including a vertical face. However, it may be more difficult to determine whether the face included in the image is a vertical face or a slope than to determine the structure included in the image. Therefore, the water level determination unit 150 may select an image including a predetermined structure (for example, a structure including a vertical face).

Further, the structures include a structure in which a trace of a flood is likely to remain appropriately and a structure in which a trace of a flood is unlikely to remain appropriately. For example, a stone fence, a utility pole, and a concrete wall provided on a wide road are likely to appropriately leave a trace of a flood. On the other hand, a wall of a narrow alley and an inclined face such as a slope for a wheelchair are unlikely to appropriately leave a trace of a flood. Therefore, the water level determination unit 150 may select and use an image including a structure in which a trace of a flood is likely to remain.

In these cases, the water level determination unit 150 may request the image acquisition unit 140 to acquire an image (for example, an image including a vertical face or an image including a structure in which a trace is likely to remain) satisfying a predetermined condition from the dashcam 30. The image acquisition unit 140 may acquire an image satisfying the requested condition from the dashcam 30 based on a request from the water level determination unit 150.

The water level determination unit 150 may determine the water level using a plurality of images in order to reduce the determination error. For example, when there is a plurality of images including the same point, the water level determination unit 150 may determine the water level at the point using the plurality of images. For example, the water level determination unit 150 may use an average value of water levels determined using a plurality of respective images as the water level at the point. Alternatively, the water level determination unit 150 may use, as the water level, a value calculated by applying a predetermined statistical process (for example, an arithmetic average value or a weighted average value in consideration of a distance) to the water levels at a plurality of points. For example, the water level determination unit 150 may use, as the water level, a value calculated by applying a predetermined statistical process (for example, an average value or a weighted average value in consideration of a distance) to a plurality of water levels determined using images of a point where the water level is determined and a nearby point.

Alternatively, the water level determination unit 150 may exclude, as the abnormal value, a water level that does not fall within a range of a predetermined times the variance or the standard deviation obtained from the plurality of water levels determined using the image within the predetermined range. Alternatively, the water level determination unit 150 may determine the water level of a region having a predetermined size instead of the water level at each point. For example, water level determination unit 150 may determine the water level of a predetermined section (for example, a section for management by a local government or a section obtained by dividing an investigation region into a predetermined number of sections) using the water level included in the section as the water level of the flood. For example, the water level determination unit 150 may set the average value of the water levels in the sections as the water level of the section.

The trace of the flood may have moved before the image is acquired. Alternatively, the determination using image recognition may include a determination error. That is, the determination of the water level by the water level determination unit 150 may be erroneous determination. Therefore, the water level determination unit 150 may determine the erroneously determined water level using predetermined information. Hereinafter, the determination is referred to as “determination of the water level” including “determination of the erroneously determined water level” in order to avoid complication of the description.

For example, the disaster investigation assistance device 10 can determine the water level in the range of the flood using a change in the ground surface that is the result of the analysis using the measurement result by the SAR 20 with the accuracy (for example, about m) that is lower than the accuracy (for example, about several centimeters) of the determination using the image. Therefore, in order to avoid erroneous determination in determination of the water level, the water level determination unit 150 may determine the water level determined, using the image using the water level determined using the change in the ground surface. Hereinafter, for convenience of description, the water level determined using the image acquired by the dashcam 30 is referred to as a “first water level”. The water level determined using the measurement result or the change in the ground surface acquired from the SAR 20 is referred to as a “second water level”.

For example, the water level determination unit 150 may use a first water level included in a predetermined range (for example, a range of equal to less than 2 m) with respect to the second water level in the first water level. That is, the water level determination unit 150 may select the first water level using the second water level. Alternatively, the water level determination unit 150 may exclude, as an erroneous determination, a water level included in a predetermined range (for example, a range of more than 2 m) with respect to the second water level in the first water level. In this manner, the water level determination unit 150 may determine the water level (first water level) determined using the image, using the water level (second water level) in the range of the flood or the investigation range determined using the change in the ground surface.

The configuration for determining the second water level is not limited. For example, the range determination unit 110 may determine the second water level using the acquired change in the ground surface, and output the determined second water level to the water level determination unit 150. Alternatively, the water level determination unit 150 may acquire the range of the flood or the change in the ground surface in the investigation region from the range determination unit 110, and determine the second water level in the investigation region using the acquired change in the ground surface. The range determination unit 110 or the water level determination unit 150 may use an any method as a method used for determining the second water level. For example, the range determination unit 110 or the water level determination unit 150 may determine the second water level using predetermined image recognition.

The spatial resolution in measuring the SAR 20 is generally lower than the spatial resolution of a determination using an image from the dashcam 30. That is, the spatial resolution of the second water level is lower than the spatial resolution of the first water level. Therefore, a plurality of first water levels may be related to the second water level. Therefore, when the plurality of first water levels is related to one second water level, the water level determination unit 150 may select a predetermined first water level from the first water levels related to the second water levels. For example, the water level determination unit 150 may select the first water level closest to the value of the second water level from among the first water levels related to the second water level. Alternatively, the water level determination unit 150 may set the average value of a predetermined number of first water levels starting from a first water level with a value closer to a value of the second water level as the first water level. In this manner, water level determination unit 150 may determine the first water level using the second water level.

In determination of the second water level, there is a possibility that erroneous determination occurs. Therefore, the water level determination unit 150 may determine the second water level using the first water level. For example, the water level determination unit 150 may not use the second water level different from the plurality of first water levels related to the second water level by more than a predetermined threshold value. For example, the water level determination unit 150 may compare the average value of the first water levels related to the second water level with the second water level, and may not use the second water level different from the average value of the first water levels by more than a predetermined threshold value.

The information used to determine the first water level is not limited to the second water level determined using the change in the ground surface. The water level determination unit 150 may determine erroneous determination of the first water level using information acquired from a predetermined device. For example, the water level determination unit 150 may determine the first water level using a water level measured by a predetermined facility such as a water level observation station near a point where the water level is determined. More specifically, for example, the water level determination unit 150 may determine that a first water level in which a difference from a water level measured by a nearby water level observation station is larger than a threshold value is a water level erroneously determined, and exclude the first water level. In this case, the water level determination unit 150 may use the elevation as the water level. As described above, the water level determination unit 150 may use the water level measured by the water level observation station as the second water level in addition to or instead of the second water level determined using the change in the ground surface acquired from the SAR 20. The water level determination unit 150 may associate the first water level with the second water level. When the second water level is associated with the first water level, the water level determination unit 150 may not make the determination of the first water level using the second water level. For example, the disaster investigation assistance device 10 may output the relevance between the first water level and the second water level, and leave the determination of the first water level using the second water level to the user or the like.

The water level determination unit 150 may determine accuracy of the determination of the first water level. For example, when image recognition is used, the water level determination unit 150 may determine accuracy of the determination of the water level of the image recognition. Further, the water level determination unit 150 may determine a rank related to accuracy. The rank is obtained by classifying accuracy into a predetermined number by the user or the like. For example, the rank is obtained by classifying accuracy into three (for example, three ranks of high, medium, and low). In this case, the water level determination unit 150 may classify the accuracy of determination of the water level into a predetermined rank (for example, any one of three ranks with high/medium/low accuracy).

Then, the water level determination unit 150 outputs the determined first water level to the water level output unit 160. The water level determination unit 150 may store the first water level in a storage unit (not illustrated). The water level determination unit 150 may output the second water level in association with the first water level. Alternatively, the water level determination unit 150 may output the image using for determining the water level in association with the water level. Alternatively, the water level determination unit 150 may output the determined accuracy. Further, the water level determination unit 150 may output the rank of the accuracy.

The water level output unit 160 outputs the water level determined by the water level determination unit 150 to a predetermined device (for example, the display device 40). The water level output unit 160 may output the water level in association with the map information. The map information output by the water level output unit 160 may be the same as the map information used by at least any one of the investigation region extraction unit 120, the image acquisition unit 140, and the water level determination unit 150, or may be different from neither map information. Further, the water level output unit 160 may output an image used for determining the water level. For example, the water level output unit 160 may output an image related to at least part of the determined position of the water level.

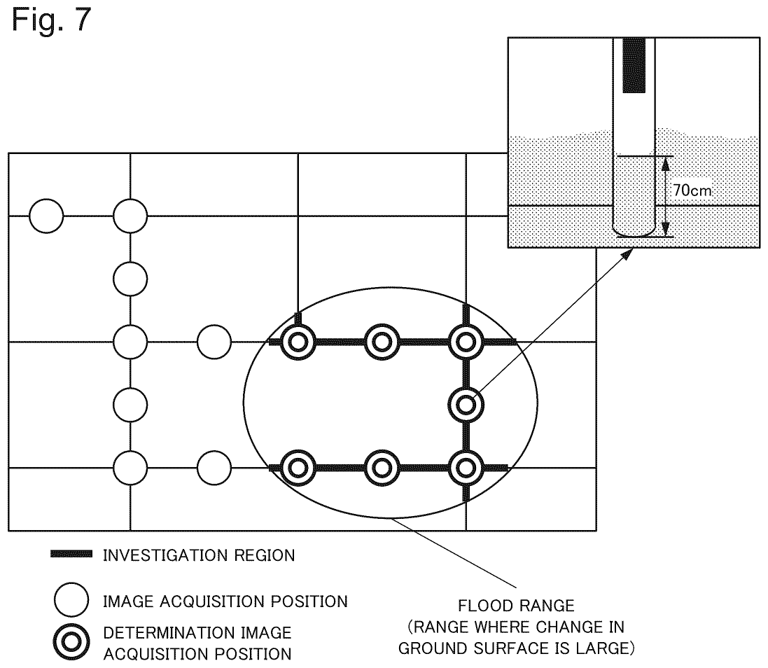

FIG. 7 is a diagram illustrating an example of output of an image. FIG. 7 is a display example of the image (for example, an image in the side direction with respect to the traveling direction of the vehicle on which the dashcam 30 is mounted) of the determination image acquisition position at which the arrow appears. For example, the display device 40 may operate as follows to display an image. The display device 40 displays a screen as illustrated in FIG. 5. The user places the cursor at a desired position in the displayed image and clicks the position. The display device 40 requests the disaster investigation assistance device 10 for an image of the clicked position, and displays the image acquired from the disaster investigation assistance device 10 as illustrated in FIG. 7.

When outputting an image, the water level output unit 160 may output information related to the image (image related information). For example, when outputting an image, the water level output unit 160 may output at least any one of the imaging condition (for example, weather) and information added by the operator (for example, the comment from the operator). When the water level determination unit 150 determines accuracy of determination, the water level output unit 160 may output the accuracy in association with the water level. Alternatively, when the water level determination unit 150 classifies the accuracy into a predetermined rank, the water level output unit 160 may output the determined rank. Further, the water level output unit 160 may output at least any one of the range of the flood and the investigation region. Alternatively, when the water level determination unit 150 associates the first water level with the second water level, the water level output unit 160 may output the second water level in association with the first water level. Alternatively, the water level output unit 160 may output a change in the ground surface. In the case of outputting the change in the ground surface, the water level output unit 160 may output at least any one of the measurement result (for example, an SAR image) used for analyzing the change in the ground surface and the measurement time of the measurement result in association with the change in the ground surface. The display device 40 may display the output information related to each case. Alternatively, the display device 40 may request information to be output from the disaster investigation assistance device 10.

FIG. 7 displays an image of the investigation region. However, the disaster investigation assistance device 10 may output an image of a region different from the investigation region. For example, the disaster investigation assistance device 10 may output an image of a point not included in the investigation region. However, the disaster investigation assistance device 10 does not acquire an image of a point not included in the investigation region. Therefore, in such a case, the disaster investigation assistance device 10 may acquire an image of a point not included in the investigation region from the dashcam 30.

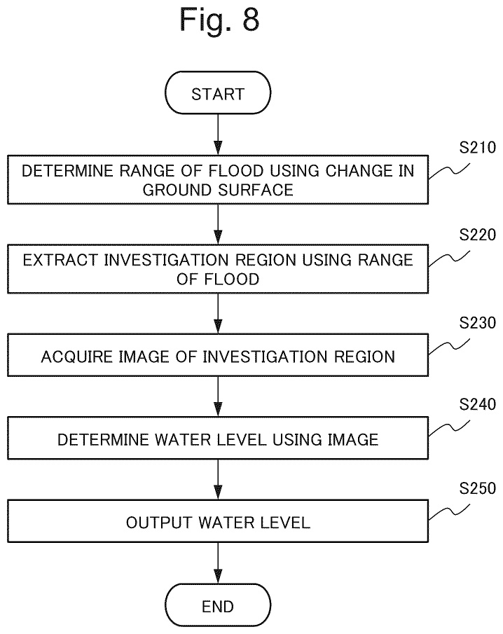

Next, the operation of the disaster investigation assistance device 10 will be described with reference to the drawings. FIG. 8 is a flowchart illustrating an example of the operation of the disaster investigation assistance device 10 according to the first example embodiment. The range determination unit 110 determines the range of the flood using a change in the ground surface that is a result of an analysis using the measurement result of the SAR 20 (step S210). The range determination unit 110 may determine the type of the ground surface and determine the range of the flood using the type of the ground surface in addition to the change in the ground surface. Further, the range determination unit 110 may determine the water level (second water level) of the flood using the change in the ground surface in the range of the flood.

The investigation region extraction unit 120 extracts an investigation region of the flood based on the range of the flood (step S220). The investigation region extraction unit 120 may use map information to extract the investigation region. The image acquisition unit 140 acquires an image of the investigation region from the dashcam 30 (step S230). The image acquisition unit 140 may acquire an image including a predetermined structure (for example, a structure including a vertical face). Alternatively, the image acquisition unit 140 may acquire an image related to a predetermined facility.

The water level determination unit 150 determines the water level (first water level) of the flood using the image (step S240). The water level determination unit 150 may determine a trace of the flood using the image, and determine the water level (first water level) of the flood using the determined trace. The water level determination unit 150 may determine the first water level using the second water level. At this time, the water level determination unit 150 may acquire a change in the ground surface from the range determination unit 110 and determine the second water level. The water level determination unit 150 may determine the accuracy and the rank of the determination of the water level.

Then, the water level output unit 160 outputs the water level to a predetermined device (for example, the display device 40) (step S250). The water level output unit 160 may output the water level in association with the map information. Further, the water level output unit 160 may output at least any one of an image related to the water level, information related to the image, accuracy of determination, and a rank of the accuracy in association with the water level.

As described above, the disaster investigation assistance device 10 according to the first example embodiment includes the range determination unit 110, the investigation region extraction unit 120, the image acquisition unit 140, and the water level determination unit 150. The range determination unit 110 determines a disaster range using a change in a ground surface that is a result of an analysis using a measurement result (for example, an SAR image) by the ground surface measurement device (for example, the SAR 20). The investigation region extraction unit 120 extracts the investigation region based on the disaster range. The image acquisition unit 140 acquires an image acquired in the investigation region by the image acquisition device (for example, the dashcam 30). The water level determination unit 150 determines the first water level in the investigation region using the acquired image.

The disaster investigation assistance device 10 improves the accuracy of the investigation of the disaster situation. For example, the disaster investigation assistance device 10 determines a disaster range using a change in a ground surface that is a result of an analysis using a measurement result (for example, an SAR image) by the ground surface measurement device (for example, the SAR 20), and extracts an investigation region where an image is acquired based on the determined disaster range. The SAR 20 and the like can measure the ground surface even in the event of a disaster such as a flood. Therefore, the disaster investigation assistance device 10 can narrow down an appropriate investigation region using a change in the ground surface at the time of a disaster such as a flood. That is, the disaster investigation assistance device 10 reduces the number of man-hours of the operator or the like in investigation of the water level. Then, the disaster investigation assistance device 10 acquires the sensor information about the investigation range, and determines the water level related to the disaster such as the water level of the flood using the acquired sensor information. Therefore, the disaster investigation assistance device 10 improves the accuracy of the investigation of the disaster situation. Further, since the disaster investigation assistance device 10 determines the water level using the sensor information, the disaster investigation assistance device 10 reduces the number of man-hours of the operator or the like in determination of the water level, and further reduces the occurrence of variations in accuracy in the determination.

The investigation region extraction unit 120 may extract the investigation region using the map information. In this case, the disaster investigation assistance device 10 can more appropriately extract the investigation region. Further, the investigation region extraction unit 120 may extract an investigation region through which the vehicle can pass. In this case, the disaster investigation assistance device 10 can quickly acquire an image using the dashcam 30 or the like mounted on the vehicle as an image acquisition device that acquires an image. As a result, the disaster investigation assistance device 10 can achieve the image acquisition in which the man-hours of the operator and the like in acquisition of the image and the image acquisition time are reduced.

The investigation region extraction unit 120 may extract an investigation region related to a predetermined facility. In this case, the disaster investigation assistance device 10 determines the water level at an appropriate position related to a predetermined facility as the determination of the water level. The investigation region extraction unit 120 may use a facility including at least any one of a water level observation station and a water gate as the facility. In this case, the disaster investigation assistance device 10 can determine the water level related to the facility related to the water level.

The investigation region extraction unit 120 may extract the investigation region using the type of the ground surface. In this case, the disaster investigation assistance device 10 can more appropriately extract the investigation region. The type of the ground surface may include at least any one of a water surface, mud, dry soil, a grassland, a forest, and snow cover. For example, it is difficult to acquire an image in a forest region. The investigation region extraction unit 120 can extract an investigation region avoiding a region such as a forest where it is difficult to obtain an image using the type of the ground surface. In this way, when the type of the ground surface is used, the disaster investigation assistance device 10 can extract an appropriate investigation region.

The image acquisition unit 140 may acquire an image from at least any one of the fixed image acquisition device (for example, a fixed camera) and the image acquisition device (for example, the dashcam 30) mounted on the vehicle. For example, the fixed camera installed on top of a steel tower or a building may be able to acquire an image even in the event of a flood. Alternatively, the image acquisition unit 140 may acquire an image acquired by the dashcam 30 equipped with a telephoto camera at a position away from the range of the flood (that is, a safe position). For example, the image acquisition unit 140 may acquire an image acquired by a camera mounted on a relay vehicle of a television at a position away from a range of a flood (that is, a safe position). In this manner, the image acquisition unit 140 may acquire an image at the time of disaster (for example, in the event of a flood), not after disaster (for example, after a flood). Then, the water level determination unit 150 may determine the water level using an image at the time of disaster (for example, in the event of a flood). In this case, the water level determination unit 150 can determine the water level at the time of disaster.

Alternatively, when the dashcam 30 mounted on the vehicle is used, a load of acquiring the image is reduced as compared with a case where the dashcam 30 is carried on foot. The travel time of the vehicle to the image acquisition position is shorter than that of walking. Therefore, the disaster investigation assistance device 10 can quickly acquire an image using the dashcam 30 mounted on the vehicle. As a result, the disaster investigation assistance device 10 can determine the water level more appropriately.

The water level determination unit 150 may determine the first water level using a trace included in the image acquired in the investigation region. In this case, the disaster investigation assistance device 10 can perform a trace investigation after a disaster such as after a flood in an appropriate investigation region while reducing the number of man-hours of the operator and reducing the determination of the variation in accuracy in the determination. Further, at least some of the images acquired in the investigation region may include a trace on a predetermined structure. Some structures tend to leave traces. Therefore, the water level determination unit 150 can improve the accuracy of determination of the water level using the image including such a structure. Further, the predetermined structure may be a structure including a vertical face. The trace on the vertical face is more likely to remain appropriately than that on the slope. Therefore, when an image including a structure including a vertical face is used, the disaster investigation assistance device 10 can improve the accuracy in determination of the water level.

Furthermore, the image acquisition unit 140 may acquire an image in which the trace includes at least any one of mud, garbage, and grass, driftwood, a rock, and a trace of earth and sand that have flowed out. These traces are traces appropriate for trace investigation of a disaster such as a flood. Therefore, the disaster investigation assistance device 10 can achieve an appropriate trace investigation.

Further, the water level determination unit 150 may determine a trace using image recognition. The disaster investigation assistance device 10 can automatically determine the water level using the trace using the above configuration. As a result, the disaster investigation assistance device 10 can reduce man-hours of the operator in determination of the water level and reduce variations in accuracy. The trace may include a plurality of types of traces. Then, the water level determination unit 150 may determine a trace using image recognition related to each of types of traces. The disaster investigation assistance device 10 can automatically determine the water level using a plurality of types of traces using the above configuration. As a result, even when a plurality of types of traces remains, the disaster investigation assistance device 10 can reduce the number of man-hours of the operator in determination of the water level and reduce the variation in accuracy.

The water level determination unit 150 may determine the accuracy of image recognition. In this case, the disaster investigation assistance device 10 can provide the accuracy in determination of the water level. Further, the water level determination unit 150 may determine a rank of accuracy. In this case, the disaster investigation assistance device 10 can provide the rank as an outline of the accuracy in determination of the water level. The water level determination unit 150 may determine the first water level using the elevation. The elevation of the water surface of the flood water in a flood or the like is a value obtained by adding the height from the ground surface to a trace to the elevation of the ground surface. The disaster investigation assistance device 10 can determine the elevation of the water surface at the time of disaster such as flood using the above configuration.

The water level determination unit 150 may determine the first water level using a statistical process using a plurality of images. In this case, the disaster investigation assistance device 10 can determine the water level with a further reduced error. The water level determination unit 150 may determine the first water level using information related to the image. In this case, the water level determination unit 150 can determine the water level more accurately using the information related to the image. The information related to the image may include at least any one of acquisition information about the image, operation information about the mobile object on which the image acquisition device is mounted, information added by the operator, and surrounding information. In this case, the water level determination unit 150 can determine the water level more accurately using these pieces of information.

The water level determination unit 150 may determine the first water level (the water level determined using the image) using the second water level in the disaster range determined using the change in the ground surface. In this case, the disaster investigation assistance device 10 can reduce erroneous determination in determination of the first water level. The water level determination unit 150 may determine the second water level using the first water level. For example, the water level determination unit 150 may determine the inappropriate second water level using the plurality of first water levels. In this case, the disaster investigation assistance device 10 can reduce erroneous determination of the second water level.

The water level determination unit 150 may determine the first water level using the water level measured by the water level observation station. In this manner, the disaster investigation assistance device 10 may determine the first water level using information different from a change in the ground surface. As a result, the disaster investigation assistance device 10 can determine the first water level more appropriately. Further, the water level determination unit 150 may associate the second water level with the first water level. In this case, the disaster investigation assistance device 10 can provide the second water level related to the first water level, that is, a relationship between the first water level and the second water level.

The disaster investigation assistance device 10 may include the water level output unit 160 that outputs the determined first water level. The disaster investigation assistance device 10 can provide the determined water level to the user or the like using this configuration. The water level output unit 160 may output the first water level and the map information in association with each other. Using this configuration, the disaster investigation assistance device 10 can provide the user or the like with the determined water level in association with a map. As a result, the user or the like can easily grasp the position of the water level. That is, the convenience of the user is improved.

The water level output unit 160 may output an image related to the first water level. With such a configuration, the disaster investigation assistance device 10 can provide an image related to the water level to the user or the like. As a result, the user or the like can more appropriately grasp the disaster situation using the image. The water level output unit 160 may output information (for example, the imaging condition or the comment from the operator) related to the image. In this case, the disaster investigation assistance device 10 can provide the user or the like with information related to the image as additional information in addition to the image.

The water level output unit 160 may output the first water level and the accuracy of determination of the first water level. In this case, the user or the like can determine not only the output water level but also countermeasures or the like using the accuracy using the accuracy of the output determination. Further, the water level output unit 160 may output the first water level and a rank of accuracy of the first water level. In this case, the disaster investigation assistance device 10 may provide a rank related to the accuracy with respect to the determination of the first water level. The user or the like can determine an outline of accuracy of determination of the water level referring to the rank.

The water level output unit 160 may output the first water level, an image, and information related to the image. In this case, the disaster investigation assistance device 10 can provide the user or the like with information for determining the water level in addition to the image. The water level output unit 160 may output the second water level related to the first water level. In this case, the disaster investigation assistance device 10 may provide the second water level related to the first water level. As a result, the user or the like can determine the first water level referring to the second water level.

The disaster investigation assistance system 80 includes the disaster investigation assistance device 10, the ground surface measurement device (for example, the SAR 20), the image acquisition device (for example, the dashcam 30), and the display device 40. The disaster investigation assistance device 10 operates as described above. The ground surface measurement device (for example, the SAR 20) outputs a measurement result (for example, an SAR image) to the disaster investigation assistance device 10. The image acquisition device (for example, the dashcam 30) outputs an image to the disaster investigation assistance device 10. The display device 40 displays the water level determined by the disaster investigation assistance device 10. The disaster investigation assistance system 80 can provide a water level to the user or the like using these configurations.

### [Hardware Configuration]

Next, a hardware configuration of the disaster investigation assistance device 10 will be described. Each component of the disaster investigation assistance device 10 may be configured by a hardware circuit. Alternatively, in the disaster investigation assistance device 10, each component may be configured using a plurality of devices connected via a network. For example, the disaster investigation assistance device 10 may be configured using cloud computing. Alternatively, in the disaster investigation assistance device 10, the plurality of components may be configured by one piece of hardware. Alternatively, the disaster investigation assistance device 10 may be achieved as a computer device including a central processing unit (CPU), a read only memory (ROM), and a random access memory (RAM). In addition to the above configuration, the disaster investigation assistance device 10 may be achieved as a computer device including a network interface circuit (NIC).

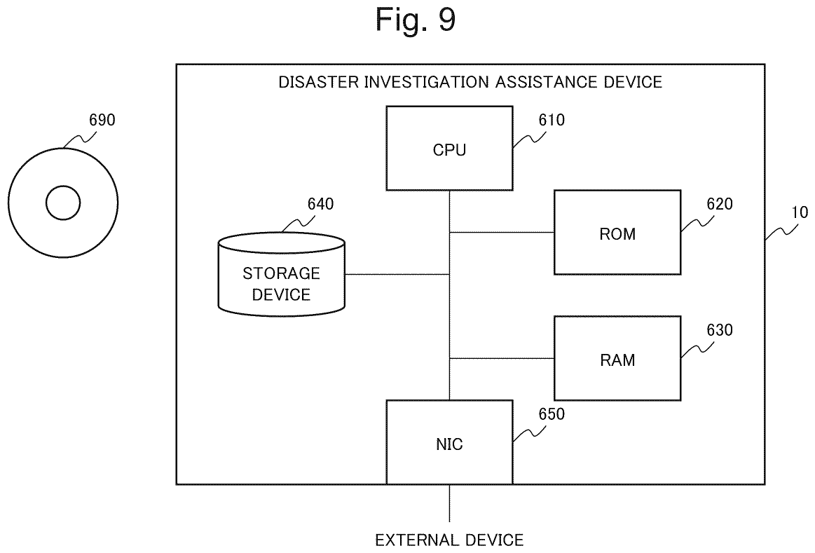

FIG. 9 is a block diagram illustrating an example of a hardware configuration of the disaster investigation assistance device 10. The disaster investigation assistance device 10 includes a CPU 610, a ROM 620, a RAM 630, a storage device 640, and an NIC 650, and constitutes a computer device. The CPU 610 reads a program from at least any one of the ROM 620 and the storage device 640. Then, the CPU 610 controls the RAM 630, the storage device 640, and the NIC 650 based on the read program. Then, the computer device including the CPU 610 controls these configurations to achieve the functions of the range determination unit 110, the investigation region extraction unit 120, the image acquisition unit 140, the water level determination unit 150, and the water level output unit 160 illustrated in FIG. 1.

When implementing each function, the CPU 610 may use the RAM 630 or the storage device 640 as a temporary storage medium of programs and data. Alternatively, the CPU 610 may read the program included in the recording medium 690 storing the program in a computer readable manner using a recording medium reading device (not illustrated). Alternatively, the CPU 610 may receive a program from an external device (not illustrated) via the NIC 650, store the program in the RAM 630 or the storage device 640, and operate based on the stored program.

The ROM 620 stores programs executed by the CPU 610 and fixed data. The ROM 620 is, for example, a programmable ROM (P-ROM) or a flash ROM. The RAM 630 temporarily stores programs and data executed by the CPU 610. The RAM 630 is, for example, a dynamic-RAM (D-RAM). The storage device 640 stores data and programs to be stored for a long term by the disaster investigation assistance device 10. Specifically, the storage device 640 operates at least as the map information storage unit 130. The storage device 640 may operate as a temporary storage device of the CPU 610. The storage device 640 is, for example, a hard disk device, a magneto-optical disk device, a solid state drive (SSD), or a disk array device.

The ROM 620 and the storage device 640 are non-transitory recording media. On the other hand, the RAM 630 is a transitory recording medium. The CPU 610 is operable based on a program stored in at least any one of the ROM 620, the storage device 640, and the RAM 630. That is, the CPU 610 is operable using at least any one of a nonvolatile recording medium and a volatile recording medium.

The NIC 650 relays exchange in data with an external device (for example, the SAR 20, the dashcam 30, the display device 40, and the information providing device 50) via a network. The NIC 650 is, for example, a local area network (LAN) card. Furthermore, the NIC 650 is not limited to use wired communication, but may use wireless communication. The disaster investigation assistance device 10 configured as described above can obtain the effects similar to those of the disaster investigation assistance device 10 of FIG. 1. This is because the CPU 610 of the disaster investigation assistance device 10 can achieve the function same as that of the disaster investigation assistance device 10 of FIG. 1 based on the program.

### Second Example Embodiment

The disaster investigation assistance device 10 may use a measurement result (for example, an SAR image), map information, and an image stored in a device (not illustrated) (for example, a storage device or a storage system in a predetermined cloud). In this case, the disaster investigation assistance device 10 may not include the map information storage unit 130. Alternatively, the disaster investigation assistance device 10 may store the determined water level in a device (not illustrated) (for example, a storage device or a storage system in a predetermined cloud). Therefore, such a case will be described as a second example embodiment.

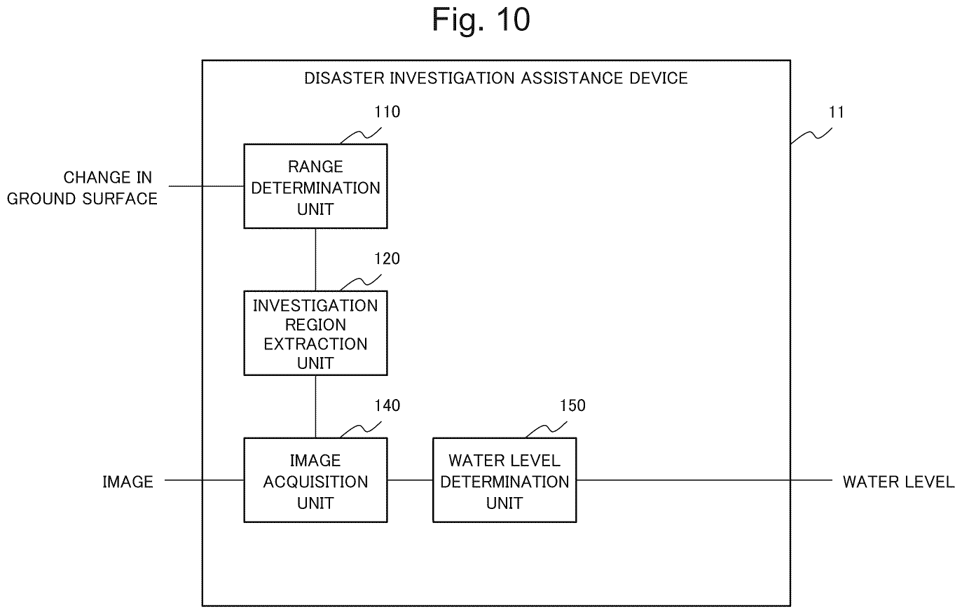

FIG. 10 is a block diagram illustrating an example of a configuration of a disaster investigation assistance device 11 according to the second example embodiment. The disaster investigation assistance device 11 includes the range determination unit 110, the investigation region extraction unit 120, the image acquisition unit 140, and the water level determination unit 150. The range determination unit 110 determines a disaster range using a change in a ground surface that is a result of an analysis using a measurement result (for example, an SAR image) by the ground surface measurement device (for example, the SAR 20). The investigation region extraction unit 120 extracts the investigation region based on the disaster range. The image acquisition unit 140 acquires an image acquired in the investigation region by the image acquisition device (for example, the dashcam 30). The water level determination unit 150 determines the first water level in the investigation region using the acquired image. The disaster investigation assistance device 11 may be configured using a hardware configuration illustrated in FIG. 9. The disaster investigation assistance device 11 configured as described above can obtain the effects similar to those of the disaster investigation assistance device 10.

### Third Example Embodiment

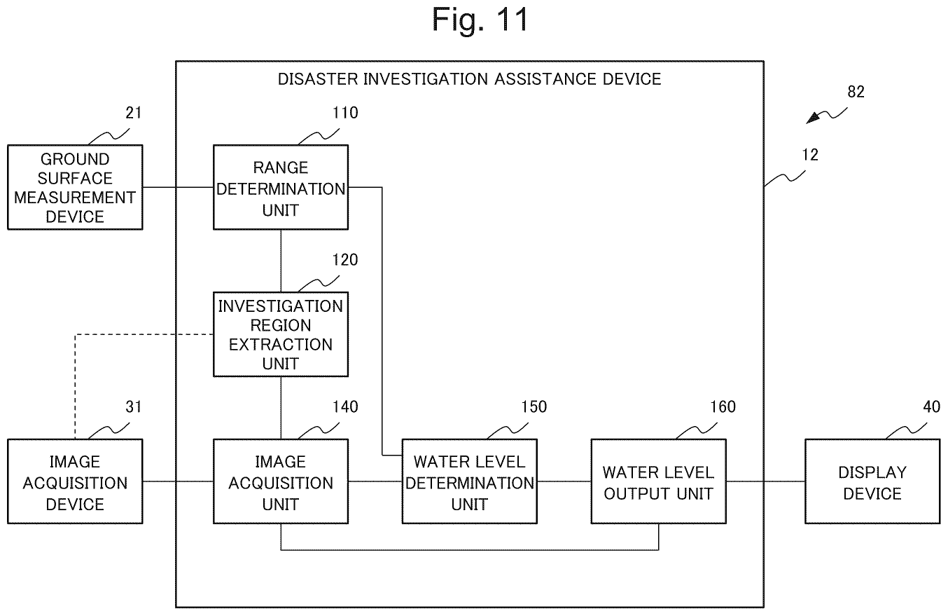

The disaster investigation assistance device 10 may acquire map information from a device (not illustrated) and may not include the map information storage unit 130. Alternatively, the disaster investigation assistance device 10 may not acquire information from the information providing device 50. Therefore, an example of the disaster investigation assistance system 80 in such a case will be described as a third example embodiment. FIG. 11 is a block diagram illustrating an example of a configuration of a disaster investigation assistance system 82 according to the third example embodiment.

The disaster investigation assistance system 82 includes a disaster investigation assistance device 12, a ground surface measurement device 21, an image acquisition device 31, and the display device 40. The disaster investigation assistance device 12 includes the range determination unit 110, the investigation region extraction unit 120, the image acquisition unit 140, the water level determination unit 150, and the water level output unit 160. The disaster investigation assistance device 12 operates as in the disaster investigation assistance device 10 except that map information is acquired from a device (not illustrated). The disaster investigation assistance device 12 may be configured using a hardware configuration illustrated in FIG. 9. The ground surface measurement device 21 (for example, the SAR 20) outputs a change in the ground surface to the disaster investigation assistance device 12. The image acquisition device 31 (for example, the dashcam 30) outputs an image to the disaster investigation assistance device 12. The display device 40 displays the water level output by the disaster investigation assistance device 12.

In the disaster investigation assistance system 82 configured as described above, the disaster investigation assistance device 12 acquires a change in a ground surface that is a result of an analysis using the measurement result by the ground surface measurement device 21 (for example, the SAR 20). Then, the disaster investigation assistance device 12 determines a disaster range using a change in a ground surface. Then, the disaster investigation assistance device 12 extracts the investigation region based on the disaster range. Then, the disaster investigation assistance device 12 determines the water level using the image acquired by the image acquisition device 31 (for example, the dashcam 30) in the investigation region. Then, the disaster investigation assistance device 12 outputs the determined water level to the display device 40. Then, the display device 40 displays the water level. The disaster investigation assistance system 82 configured as described above can obtain effects similar to those of the disaster investigation assistance system 80.

Some or all of the above example embodiments may be described as the following Supplementary Notes, but are not limited to the following.

### (Supplementary Note 1)

A disaster investigation assistance device including

a range determination means configured to determine a disaster range using a change in a ground surface that is a result of an analysis using a measurement result by a ground surface measurement device,

an investigation region extraction means configured to extract an investigation region based on the disaster range,

an image acquisition means configured to acquire an image acquired by an image acquisition device in the investigation region, and

a water level determination means configured to determine a first water level in the investigation region using the acquired image.

### (Supplementary Note 2)

The disaster investigation assistance device according to Supplementary Note 1, in which

the investigation region extraction means extracts the investigation region using map information.

### (Supplementary Note 3)

The disaster investigation assistance device according to Supplementary Note 1 or 2, in which

the investigation region extraction means extracts the investigation region through which a vehicle is configured to pass.

### (Supplementary Note 4)

The disaster investigation assistance device according to any one of Supplementary Notes 1 to 3, in which

the investigation region extraction means extracts the investigation region related to a predetermined facility.

### (Supplementary Note 5)

The disaster investigation assistance device according to Supplementary Note 4, in which

the facility includes at least any one of a water level observation station and a water gate.

### (Supplementary Note 6)

The disaster investigation assistance device according to any one of Supplementary Notes 1 to 5, in which

a change in ground surface includes a type of a ground surface, and in which

the investigation region extraction means extracts the investigation region using a type of a ground surface.

### (Supplementary Note 7)

The disaster investigation assistance device according to Supplementary Note 6, in which

the type of the ground surface includes at least any one of a water surface, mud, garbage, dry soil, a grassland, a forest, and snow cover.

### (Supplementary Note 8)

The disaster investigation assistance device according to any one of Supplementary Notes 1 to 7, in which

the image acquisition means acquires the image from at least any one of the fixed image acquisition device and the image acquisition device mounted on a vehicle.

### (Supplementary Note 9)

The disaster investigation assistance device according to any one of Supplementary Notes 1 to 8, in which

the water level determination means determines the first water level using a trace included in the image acquired in the investigation region.

### (Supplementary Note 10)

The disaster investigation assistance device according to Supplementary Note 9, in which

at least part of the image acquired in the investigation region includes the trace on a predetermined structure.

### (Supplementary Note 11)

The disaster investigation assistance device according to Supplementary Note 10, in which

the predetermined structure is a structure including a vertical face.

### (Supplementary Note 12)

The disaster investigation assistance device according to any one of Supplementary Notes 9 to 11, in which

the trace includes at least any one of mud, garbage, grass, driftwood, a rock, and a trace of earth and sand that have flowed out.

### (Supplementary Note 13)

The disaster investigation assistance device according to any one of Supplementary Notes 9 to 12, in which

the water level determination means determines the trace using image recognition.

### (Supplementary Note 14)

The disaster investigation assistance device according to Supplementary Note 13, in which

the trace includes a plurality of types of the traces, and in which

the water level determination means determines the traces using the image recognition related to the plurality of respective types of the traces.

### (Supplementary Note 15)

The disaster investigation assistance device according to Supplementary Note 13 or 14, in which

the water level determination means determines accuracy of the image recognition.

### (Supplementary Note 16)

The disaster investigation assistance device according to Supplementary Note 15, in which

the water level determination means determines a rank of the accuracy.

### (Supplementary Note 17)

The disaster investigation assistance device according to any one of Supplementary Notes 1 to 16, in which

the water level determination means determines the first water level using an elevation.

### (Supplementary Note 18)

The disaster investigation assistance device according to any one of Supplementary Notes 1 to 17, in which

the water level determination means determines the first water level using a statistical process using a plurality of the images.

### (Supplementary Note 19)

The disaster investigation assistance device according to any one of Supplementary Notes 1 to 18, in which

the water level determination means determines the first water level using information related to the image.

### (Supplementary Note 20)

The disaster investigation assistance device according to Supplementary Note 19, in which

the information related to the image includes at least any one of acquisition information about the image, operation information about a mobile object on which the image acquisition device is mounted, information added by an operator, and surrounding information.

### (Supplementary Note 21)

The disaster investigation assistance device according to any one of Supplementary Notes 1 to 20, in which

the water level determination means determines the first water level using a second water level in the disaster range determined using the change in the ground surface.

### (Supplementary Note 22)

The disaster investigation assistance device according to Supplementary Note 21, in which

the water level determination means determines the second water level using the first water level.

### (Supplementary Note 23)

The disaster investigation assistance device according to Supplementary Note 21 or 22, in which

the water level determination means determines the first water level using a water level measured by a water level observation station.

### (Supplementary Note 24)

The disaster investigation assistance device according to any one of Supplementary Notes 21 to 23, in which

a water level determination means associates the second water level with the first water level.

### (Supplementary Note 25)

The disaster investigation assistance device according to any one of Supplementary Notes 1 to 24, further including

a water level output means configured to output the first water level.

### (Supplementary Note 26)

The disaster investigation assistance device according to Supplementary Note 25, in which

the water level output means outputs the first water level and map information in association with each other.

### (Supplementary Note 27)

The disaster investigation assistance device according to Supplementary Note 25 or 26, in which

the water level output means outputs the image related to the first water level.

### (Supplementary Note 28)

The disaster investigation assistance device according to Supplementary Note 15, further including

a water level output means configured to output the first water level and the accuracy of determination of the first water level.

### (Supplementary Note 29)

The disaster investigation assistance device according to Supplementary Note 16, further including

a water level output means configured to output the first water level and a rank of the accuracy of determination of the first water level.

### (Supplementary Note 30)

The disaster investigation assistance device according to Supplementary Note 19 or 20, further including

a water level output means configured to output the first water level, the image, and information related to the image.

### (Supplementary Note 31)

The disaster investigation assistance device according to Supplementary Note 24, further including

a water level output means configured to output the first water level and the second water level associated with the first water level.

### (Supplementary Note 32)

A disaster investigation assistance system including the disaster investigation assistance device according to any one of Supplementary Notes 1 to 31,

the ground surface measurement device that outputs the measurement result to the disaster investigation assistance device,

the image acquisition device that outputs the image to the disaster investigation assistance device, and

a display device that displays the first water level determined by the disaster investigation assistance device.

### (Supplementary Note 33)

A disaster investigation assistance method including

determining a disaster range using a change in a ground surface that is a result of an analysis using a measurement result by a ground surface measurement device,

extracting an investigation region based on the disaster range,

acquiring an image acquired by an image acquisition device in the investigation region, and

determining a first water level in the investigation region using the acquired image.

### (Supplementary Note 34)

A disaster investigation assistance method including

a disaster investigation assistance device executing the disaster investigation assistance method according to Supplementary Note 33,

the ground surface measurement device outputting the measurement result to the disaster investigation assistance device,

the image acquisition device outputting the image to the disaster investigation assistance device, and

a display device displays the first water level determined by the disaster investigation assistance device.

### (Supplementary Note 35)

A recording medium that records a program for causing a computer to execute

determining a disaster range using a change in a ground surface that is a result of an analysis using a measurement result by a ground surface measurement device,

extracting an investigation region based on the disaster range,

acquiring an image acquired by an image acquisition device in the investigation region, and

determining a first water level in the investigation region using the acquired image.

Although the present invention is described above with reference to the example embodiments, the present invention is not limited to the above example embodiments. It will be understood by those of ordinary skill in the art that various changes in form and details may be made therein without departing from the spirit and scope of the present invention as defined by the claims.

### REFERENCE SIGNS LIST

10 disaster investigation assistance device
11 disaster investigation assistance device
12 disaster investigation assistance device
20 SAR
21 ground surface measurement device
30 dashcam
31 image acquisition device
40 display device
50 information providing device
80 disaster investigation assistance system
82 disaster investigation assistance system
110 range determination unit
120 investigation region extraction unit
130 map information storage unit
140 image acquisition unit
150 water level determination unit
160 water level output unit
610 CPU
620 ROM
630 RAM
640 storage device
650 NIC
810 computer
820 SAR system
830 dashcam
840 terminal device
850 vehicle
880 network

What is claimed is:

1. A disaster investigation assistance device comprising:
a memory; and
at least one processor coupled to the memory,
the processor performing operations, the operations comprising:
determining a disaster range using a change in a ground surface that is a result of an analysis using a measurement result by a ground surface measurement device;
extracting an investigation region based on the disaster range;
acquiring an image acquired by an image acquisition device in the investigation region; and
determining a first water level in the investigation region using the acquired image.

2. The disaster investigation assistance device according to claim 1, wherein the operations further comprise:
extracting the investigation region using map information.

3. The disaster investigation assistance device according to claim 1, wherein the operations further comprise:
extracting the investigation region through which a vehicle is configured to pass.

4. The disaster investigation assistance device according to claim 1, wherein the operations further comprise:
extracting the investigation region related to a predetermined facility.

5. The disaster investigation assistance device according to claim 4, wherein
the facility includes at least any one of a water level observation station and a water gate.

6. The disaster investigation assistance device according to claim 1, wherein the operations further comprise:
extracting the investigation region using a type of a ground surface.

7. The disaster investigation assistance device according to claim 6, wherein
the type of the ground surface includes at least any one of a water surface, mud, garbage, dry soil, a grassland, a forest, and snow cover.

8. The disaster investigation assistance device according to claim 1, wherein the operations further comprise:
acquiring the image from at least any one of the fixed image acquisition device and the image acquisition device mounted on a vehicle.

9. The disaster investigation assistance device according to claim 1, wherein the operations further comprise:
determining the first water level using a trace included in the image acquired in the investigation region.

10. The disaster investigation assistance device according to claim 9, wherein
at least part of the image acquired in the investigation region includes the trace on a predetermined structure.

11. The disaster investigation assistance device according to claim 10, wherein
the predetermined structure is a structure including a vertical face.

12. The disaster investigation assistance device according to claim 9, wherein
the trace includes at least any one of mud, garbage, grass, driftwood, a rock, and a trace of earth and sand that have flowed out.

13. The disaster investigation assistance device according to claim 9, wherein the operations further comprise:
determining the trace using image recognition.

14. The disaster investigation assistance device according to claim 13, wherein
the trace includes a plurality of types of the traces, and wherein the operations further comprise:
determining the traces using the image recognition related to the plurality of respective types of the traces.

15. The disaster investigation assistance device according to claim 13, wherein the operations further comprise:
determining accuracy of the image recognition.

16. The disaster investigation assistance device according to claim 15, wherein the operations further comprise:
determining a rank of the accuracy.

17. The disaster investigation assistance device according to claim 1, wherein the operations further comprise:
determining the first water level using an elevation.

18. The disaster investigation assistance device according to claim 1, wherein the operations further comprise:
determining the first water level using a statistical process using a plurality of the images.

19-32. (canceled)

33. A disaster investigation assistance method comprising:
determining a disaster range using a change in a ground surface that is a result of an analysis using a measurement result by a ground surface measurement device;
extracting an investigation region based on the disaster range;
acquiring an image acquired by an image acquisition device in the investigation region; and
determining a first water level in the investigation region using the acquired image.

34. (canceled)

35. A non-transitory computer-readable recording medium that records a program for causing a computer to execute:
determining a disaster range using a change in a ground surface that is a result of an analysis using a measurement result by a ground surface measurement device;
extracting an investigation region based on the disaster range;
acquiring an image acquired by an image acquisition device in the investigation region; and
determining a first water level in the investigation region using the acquired image.
